(19) United States
(12) Patent Application Publication
(10) Pub. No.: US 2013/0128594 A1
(43) Pub. Date: May 23, 2013

(54) WELD-FREE OPTICAL SUB-ASSEMBLY FOR TRANSCEIVERS FOR LIGHT-EMITTING UNIT

(71) Applicant: Chih-Cheng CHIEN, Taipei (TW)

(72) Inventor: Chih-Cheng CHIEN, Taipei (TW)

(73) Assignees: EZCONN CORPORATION, Taipei (TW); Chih-Cheng CHIEN, Taipei (TW)

(21) Appl. No.: 13/300,708

(22) Filed: Nov. 21, 2011

(51) Int. Cl. F21V 15/01

(52) U.S. Cl. 362/365

(57) ABSTRACT

A weld-free optical sub-assembly for transceivers for light-emitting unit includes: a main housing including a flange end section, several threaded holes being formed on the flange end section; a light-emitting unit; and a locking structure including a collar. The collar has a sleeve sectionpositioned in the flange end section of the main housing. The sleeve section defines an inner hole for receiving the light-emitting unit. The locking structure further includes several screws. The screws are screwed into the threaded holes of the main housing until the sleeve section is inward recessed to form several locking sections in tight contact with the light-emitting unit, whereby the light-emitting unit is packaged in the main housing.

### BACKGROUND OF THE INVENTION

1. Field of the Invention

The present invention relates to a weld-free optical sub-assembly for transceivers for light-emitting unit.

2. Description of the Related Art

In an optical fiber communication system, optical sub-assembly for transceivers is an important medium for conversion between optical signals and electrical signals. The optical sub-assembly for transceivers can be classified into transmitting optical sub-assembly (TOSA) for transmitting optical signals, bi-direction optical sub-assembly (BOSA) capable of receiving bi-direction signals in the same optical fiber and tri-direction optical sub-assembly (TRI-DI OSA) capable of receiving both digital signals and analog signals and transmitting digital signals. Either of the TOSA, BOSA and TRI-DI OSA has a main housing in which a light-emitting unit is packaged. An optical coupling alignment tool is used to control the relative positions between the light-emitting unit and the optical fiber module port of a positioning stage for performing optical coupling alignment between the light-emitting unit and the optical fiber of the optical fiber module port so as to transmit optical signals. Therefore, optical alignment (optical coupling) is a very critical manufacturing process in test of the optical sub-assembly for transceivers.

The optical coupling alignment tool is an X-Y-Z precision positioning stage for controlling the relative positions between the optical fiber of the optical fiber connection port and the light source element of the light-emitting unit. After the optical coupling alignment is achieved, the connection process of the light-emitting unit can be performed.

In general, the connection process is performed by means of a laser welder. The laser welder is quite expensive. Therefore, in the connection process, in case the light-emitting unit can be affixed onto the main housing without laser welding, the manufacturing cost will be greatly lowered.

In practice, after the light-emitting unit is connected to the main housing, it still may happen that the optical coupling alignment between the light-emitting unit and the optical fiber is not achieved. In general, after laser welded, the optical element cannot be reworked and reused. This causes a great trouble to the manufacturers.

### SUMMARY OF THE INVENTION

A primary object of the present invention is to provide a weld-free optical sub-assembly for transceivers for light-emitting unit, which can be reworked and reused. The light-emitting unit can be securely connected with the main housing.

To achieve the above and other objects, the weld-free optical sub-assembly for transceivers for light-emitting unit of the present invention includes: a main housing including a flange end section, the flange end section having a receiving hole and several threaded holes formed on the flange end section; a light-emitting unit; and a locking structure including a collar. The collar has a sleeve section positioned in the receiving hole of the main housing. An annular gap is defined between the sleeve section and the flange end section of the main housing. The sleeve section defines an inner hole for receiving the light-emitting unit. An annular gap is defined between the sleeve section and the light-emitting unit. The locking structure further includes several screws. The screws are screwed into the threaded holes of the main housing until the sleeve section is inward recessed to form several locking sections in tight contact with outer surface of the light-emitting unit, whereby the light-emitting unit is packaged in the main housing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of the weld-free optical sub-assembly for transceivers for light-emitting unit of the present invention;

FIG. 2 is a perspective exploded view of the weld-free optical sub-assembly for transceivers for light-emitting unit of the present invention;

FIG. 3 is a sectional view showing that the screws have not yet been screwed into the main housing;

FIG. 4 is a sectional view according to FIG. 3, showing that the screws have been screwed into the main housing to package the light-emitting unit in the main housing;

FIG. 5 is a perspective view of a second embodiment of the weld-free optical sub-assembly for transceivers for light-emitting unit of the present invention;

FIG. 6 is a perspective exploded view according to FIG. 5; and

FIG. 7 is a sectional view according to FIG. 5, showing that the screws have been screwed into the main housing to package the light-emitting unit in the main housing.

### DETAILED DESCRIPTION OF THE PREFERRED EMBODIMENTS

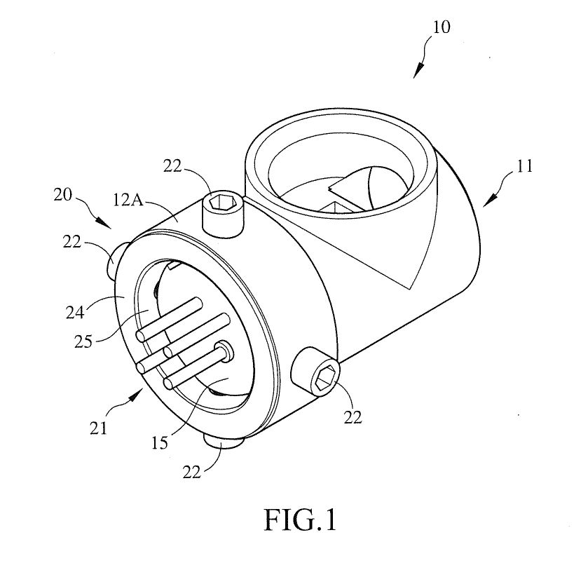

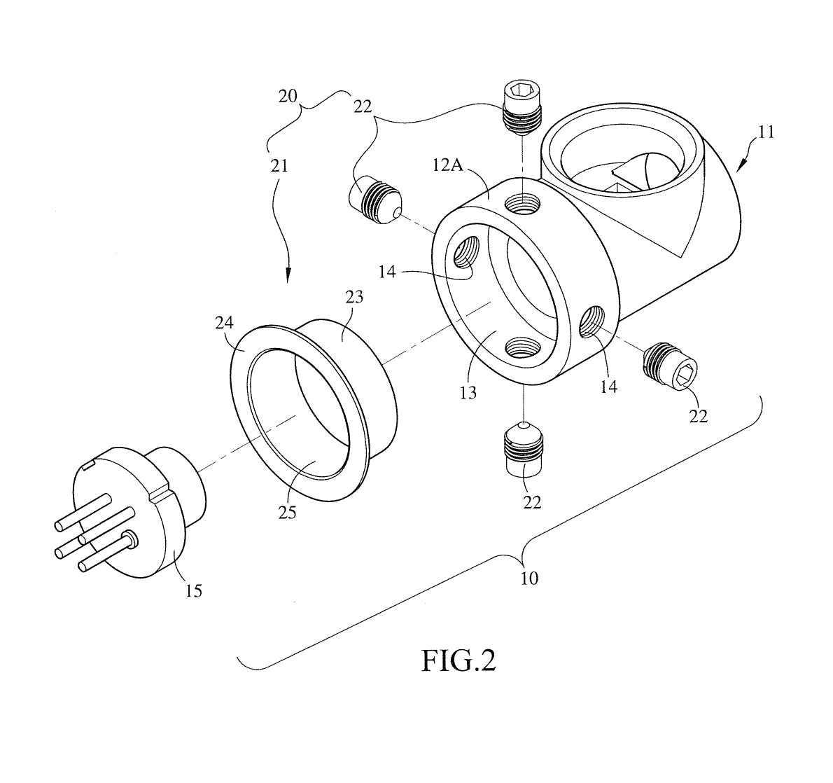

Please refer to FIGS. 1 to 3. The weld-free optical sub-assembly 10 for transceivers for light-emitting unit of the present invention includes a main housing 11, a light-emitting unit 15 and a locking structure 20. The main housing 11 includes a flange end section 12A, which has a hollow cylindrical shape or rectangular shape. In FIGS. 1 to 4, the flange end section 12A has a hollow cylindrical shape for illustration purposes. The flange end section 12A has an internal receiving hole 13 and several threaded holes 14 formed on a circumferential wall of the flange end section 12A. In general, the main housing 11 further includes several connection ports for connecting with such as a light guide unit 40 arranged in a direction reverse to that of the light-emitting unit 15 and such as a light reception unit 41 arranged in a direction normal to the axes of the light-emitting unit 15 and the light guide unit 40. Accordingly, the main housing can have a straight configuration, a T-shaped configuration or a cross-shaped configuration as well known. In this embodiment, the main housing 11 is T-shaped for illustration purposes. The present invention is characterized in that the light-emitting unit 15 is tightly connected with the main housing 11 by means of the locking structure 20.

The locking structure 20 has a collar 21 and several screws 22. The collar 21 has a sleeve section 23 positioned in the receiving hole 13 and concentric with the flange end section 12A. An annular gap S1 is defined between the sleeve section 23 and the flange end section 12A. The sleeve section 23 defines an inner hole 25 for receiving the light-emitting unit 15 therein. An annular gap S2 is defined between the sleeve section 23 and the light-emitting unit 15.

The collar 21 further has an annular outer flange 24 positioned at an end of the sleeve section 23 in abutment with an end face of the main housing 11.

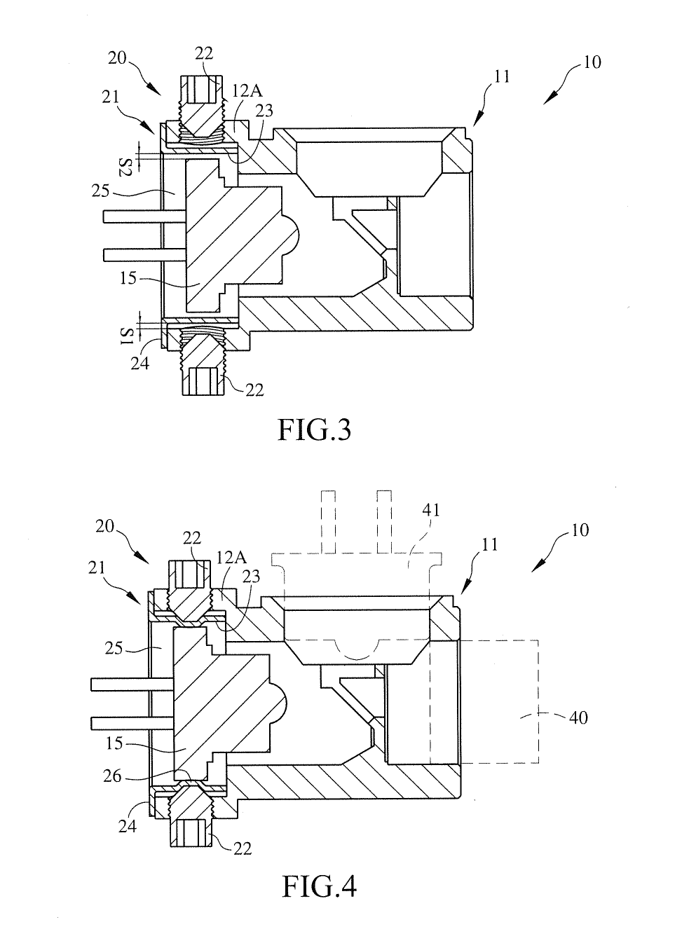

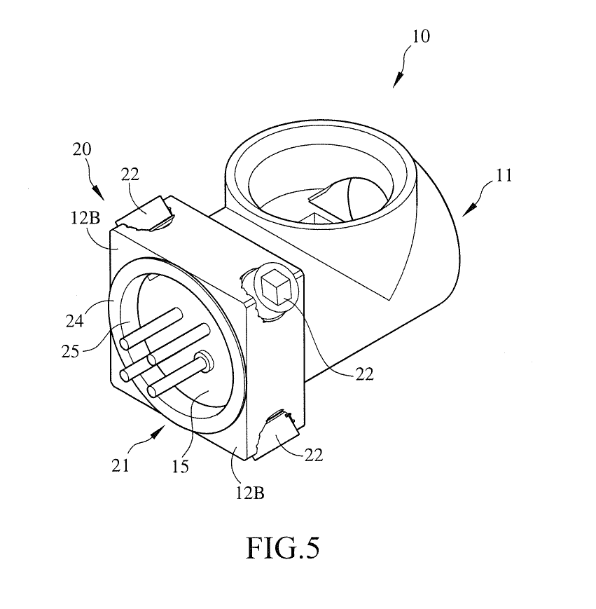

As shown in FIG. 3, when performing optical coupling alignment between the light-emitting unit 15 and the optical fiber of the light guide unit 40, the screws 22 are screwed into the threaded holes 14 of the flange end section 12A to a position close to the surface of the sleeve section 23. Then the screws 22 are further screwed to a final locking position where the sleeve section 23 is inward recessed to form several locking sections 26. The locking sections 26 are forced into contact with the outer surface of the light-emitting unit 15, whereby by means of the locking sections 26, the light-emitting unit 15 is directly tightly connected with the main housing 11 and packaged therein as shown in FIG. 4.

When the screws 22 are screwed into the threaded holes 14, the sleeve section 23 serves to prevent the light-emitting unit 15 from tilting and avoid pressmark formed on the surface of the light-emitting unit 15.

On the other hand, after the connection between the light-emitting unit 15 and the main housing 11 is completed, it may still be detected that the optical coupling alignment between the light-emitting unit 15 and the optical fiber of the pigtail light guide structure of the main housing 11 is not achieved. Under such circumstance, the screws 22 can be unscrewed to forcedly detach the light-emitting unit 15 from the collar 21. Accordingly, the main housing 11 and the light-emitting unit 15 can be reworked and reused.

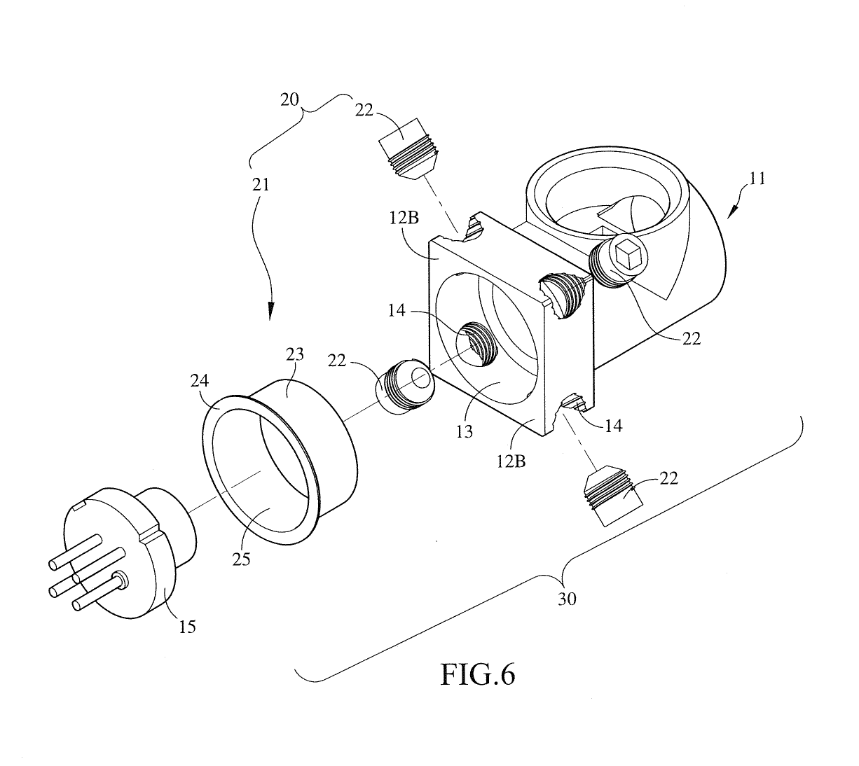

FIGS. 5 to 7 show a second embodiment of the weld-free optical sub-assembly 30 for transceivers for light-emitting unit of the present invention. The same components are denoted with the same reference numerals as in FIGS. 1 to 4. The components of the second embodiment are substantially identical to those of the first embodiment as shown in FIGS. 1 to 3. The second embodiment of the weld-free optical sub-assembly 30 for transceivers is simply different from the first embodiment in that the flange end section 12B is a rectangular structure for illustration purposes. A threaded hole 14 is formed on each of four corners of the flange end section 12B.

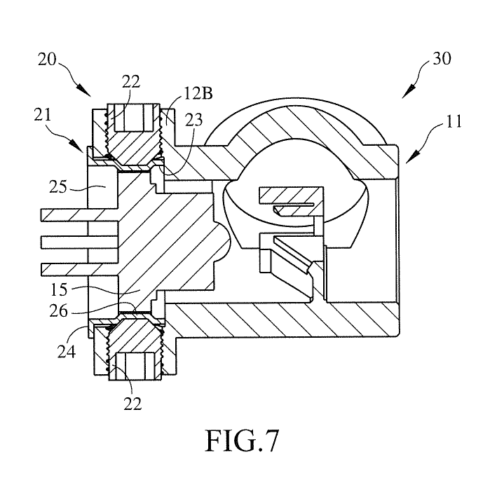

When performing optical coupling alignment between the light-emitting unit 15 and the optical fiber of the light guide unit 40, the screws 22 are screwed into the threaded holes 14 of the flange end section 12B to a position close to the surface of the sleeve section 23. Then the screws 22 are further screwed to a final locking position where the sleeve section 23 is inward recessed to form several locking sections 26. The locking sections 26 are forced into contact with the outer surface of the light-emitting unit 15, whereby by means of the locking sections 26, the light-emitting unit 15 is directly tightly connected with the main housing 11 and packaged therein as shown in FIG. 7.

The above embodiments are only used to illustrate the present invention, not intended to limit the scope thereof. It is understood that many changes or modifications of the above embodiments can be made by those who are skilled in this field without departing from the spirit of the present invention. The scope of the present invention is limited only by the appended claims.

What is claimed is:

1. A weld-free optical sub-assembly for transceivers for light-emitting unit, comprising:
a main housing including a flange end section, the flange end section having a receiving hole and several threaded holes formed on the flange end section;
a light-emitting unit; and
a locking structure including a collar, the collar having a sleeve section positioned in the receiving hole of the main housing, an annular gap being defined between the sleeve section and the flange end section of the main housing, the sleeve section defining an inner hole for receiving the light-emitting unit, an annular gap being defined between the sleeve section and the light-emitting unit, the locking structure further including several screws, the screws being screwed into the threaded holes of the main housing until the sleeve section is inward recessed to form several locking sections in tight contact with outer surface of the light-emitting unit, whereby the light-emitting unit is packaged in the main housing.

2. The weld-free optical sub-assembly for transceivers for light-emitting unit as claimed in claim 1, wherein the collar further has an annular outer flange positioned at an end of the sleeve section in abutment with an end face of the main housing.

3. The weld-free optical sub-assembly for transceivers for light-emitting unit as claimed in claim 1, wherein the flange end section has a hollow cylindrical shape and the threaded holes are formed on a circumferential wall of the flange end section.

4. The weld-free optical sub-assembly for transceivers for light-emitting unit as claimed in claim 1, wherein the flange end section has a rectangular shape and the threaded holes are formed on four corners of the flange end section.
